(19) United States
(12) Patent Application Publication
(10) Pub. No.: US 2025/0231154 A1
(43) Pub. Date: Jul. 17, 2025

(54) VIBRATION ISOLATION SYSTEM FOR CHROMATOGRAPHY SEPARATION INSTRUMENT

(71) Applicant: Wyatt Technology, LLC, Goleta, CA (US)

(72) Inventors: Steven P. Trainoff, Santa Barbara, CA (US); Zhiyong Gong, Goleta, CA (US); Anthony Clemens, Goleta, CA (US)

(21) Appl. No.: 19/014,932

(22) Filed: Jan. 9, 2025

Related U.S. Application Data
(60) Provisional application No. 63/620,657, filed on Jan. 12, 2024.

(51) Int. Cl. G01N 30/60

(52) U.S. Cl. CPC G01N 30/6047

(57) ABSTRACT

An apparatus comprises a spring foot comprising an upper housing, a lower housing comprising an anti-slip friction pad, a shoulder bolt to provide consistent spacing, and an adjustment washer to adjust a weight-set point for switching between a spring-loaded configuration and a solid-loaded configuration. The upper housing cylinder is positioned a stop-distance from a flange of the lower housing in a spring-loaded configuration, resulting in a weight-based stop. The adjustment washer is adjustable between spring-loaded configuration to a solid-loaded configuration, based on the spring constant.

### PRIORITY

This application claims priority to U.S. provisional patent application No. 63/620,657 filed Jan. 12, 2024 and titled “Vibration Isolation System for Chromatography Separation Instrument,” the entirety of which is incorporated by reference herein.

### FIELD

The present disclosure relates generating to vibration-sensitive instruments that perform a chromatographic analysis of particles.

### BACKGROUND

Dynamic light scattering and electrophoretic mobility detection measurement instruments are readily available for performing a separation and comprehensive characterization operation on macromolecules and nanoparticles from 1 to 1000 nm in size. As shown in FIG. 1, such instruments may include a field-flow fractionation (FFF) system 10, which incorporates sophisticated mass flow controllers (MFCs) that measure flow velocity by analyzing the motion of a vibrating capillary to provide robust and repeatable separations. The FFF system 10 may include a stack of instruments, such as a fraction collector 11, autosampler 12, detector 13, pump 14, and solvent tray 15. The vibration frequency used in the MFCs depends on the model type, solvent, and ambient temperature, but it is typically between 80 Hz to 160 Hz. Noise in this range is ubiquitous in laboratories, which means that the FFF 11 at the bottom of the stack 10, which uses MFCs, can be affected by environmental pickup that can compromise its performance.

Conventional techniques may be used to prevent external vibration pick-up as well as crosstalk between the various sensors. These include anchoring them to “mass blocks” and isolating them with vibration isolation gasketing. However, the instruments operated on standard lab benches have other instruments that can cause the benchtop to vibrate. These include pumps and degassers, as well as users working on benchtops. Even with the internal vibration isolations, evidence of pickup that manifest as noisy flow measurements are seen, even when there is no flow applied. Other techniques to mitigating undesirable vibration include the use of rubber isolation feet may be insufficient. Moreover, when the stack 10 may a full stack of instruments (11, 12, 13, 14, 15) or may be lightly loaded by a subset. Soft feet that work well for vibration isolation of a light stack, may destabilize the balance of a heavy stack, causing it to wobble. What is needed is an isolation solution that is soft enough to effectively dampen vibration pickup when lightly loaded, but that remains stable when heavily loaded. The subject of this disclosure is to a simple solution to this problem that includes an adjustable spring that can be set to float the vibration sensitive component 11, when lightly loaded, but that becomes sold when heavily loaded.

### SUMMARY

In one aspect, an apparatus comprises a spring foot comprising an upper housing, a lower housing comprising an anti-slip friction pad, a shoulder bolt to provide consistent spacing, and an adjustment washer to adjust a weight-set point for switching between a spring-loaded configuration and a solid-loaded configuration. The upper housing cylinder is positioned a stop-distance from a flange of the lower housing in a spring-loaded configuration, resulting in a weight-based stop. The adjustment washer is adjustable between spring-loaded configuration to a solid-loaded configuration, based on the spring constant.

In another aspect, a foot assembly for at least one vibration-sensitive analytical instrument includes an upper housing coupled to an instrument of at least one vibration-sensitive analytical instrument; a lower housing constructed and arranged for positioning on a surface; a default gap between the upper housing and the lower housing; a coupling device extending through a center of the lower housing and coupling to the upper housing so that the upper housing can move vertically relative to the lower housing and adjust the gap according to a force applied to the upper housing; and a spring having a predetermined spring constant between the upper housing and the lower housing, the spring compressing when the force is applied to the upper housing so that the upper housing moves vertically relative to the lower housing until the default gap between the upper housing and the lower housing is reduced until the upper housing directly abuts the lower housing.

In another aspect, a vibration isolation system includes first through fourth foot assemblies, each coupled to a corner of a bottom surface of a vibration-sensitive analytical instrument. Each foot assembly includes an upper housing coupled to an instrument of at least one vibration-sensitive analytical instrument; a lower housing constructed and arranged for positioning on a surface; a default gap between the upper housing and the lower housing; a coupling device extending through a center of the lower housing and coupling to the upper housing so that the upper housing can move vertically relative to the lower housing and adjust the gap according to a force applied to the upper housing; and a spring having a predetermined spring constant between the upper housing and the lower housing, the spring compressing when the force is applied to the upper housing so that the upper housing moves vertically relative to the lower housing until the default gap between the upper housing and the lower housing is reduced until the upper housing directly abuts the lower housing. Each of the first through fourth foot assemblies has a different gap thickness to accommodate a different force.

In another aspect, the present disclosure describes a method, system, and apparatus for an instrument sensitive to vibration, and that attenuates vibration based on weight & spring constant, comprising at least one spring foot comprising an upper housing (˜cylinder) (e.g., stacked wave washer->compactness, cylindrical compression spring), a lower housing (˜piston) comprising an anti-slip friction pad, a shoulder bolt to provide consistent spacing (sets compression in spring), and an adjustment washer to adjust a weight-set point for switching between a spring-loaded configuration and a solid-loaded configuration (different washer for each of 4 feet for FFF). The upper housing cylinder is positioned a stop-distance from a flange of the lower housing in a spring-loaded configuration, resulting in a weight-based stop (integrated). The adjustment washer is adjustable between spring-loaded configuration to a solid-loaded configuration, based on the spring constant.

### BRIEF DESCRIPTION OF THE DRAWINGS

FIG. 1 is a view of a stacked arrangement of analytical instruments, in which embodiments of the present inventive concept can be applied.

FIG. 2 is an illustrative view of a spring foot assembly of a vibration isolation system, in accordance with an embodiment.

FIGS. 3 and 3A are an exploded perspective views of a spring foot assembly of a vibration isolation system, in accordance with an embodiment.

FIG. 3B is an assembled perspective view of the spring foot assembly of FIGS. 3 and 3A.

FIG. 4A depicts a spring foot assembly in accordance with an embodiment receiving a first load.

FIG. 4B depicts the spring foot assembly of FIG. 4A receiving a second load.

FIG. 5 is a bottom view of a vibration isolation system coupled to an instrument, in accordance with some embodiments.

### DETAILED DESCRIPTION

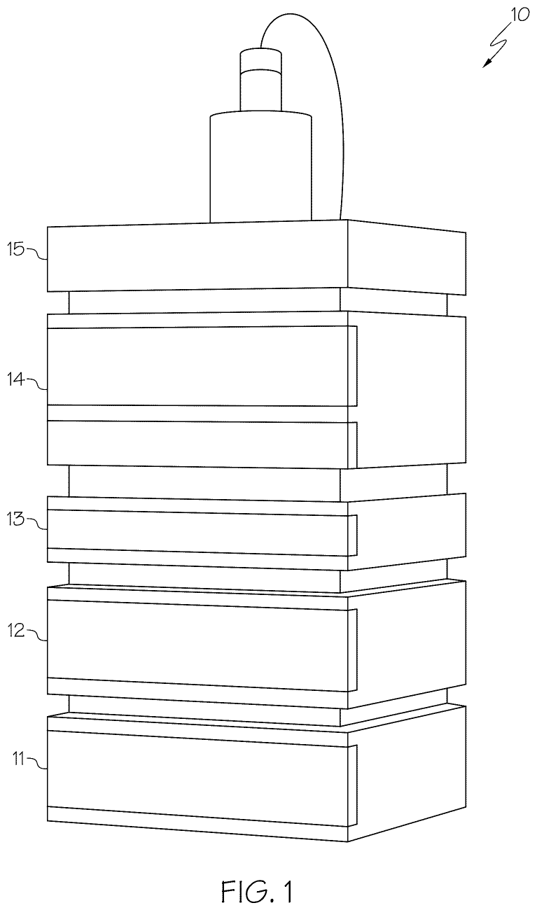

In brief overview, described are embodiments of a vibration isolation mount for the bottom of an instrument that floats the instrument so that noise in the sensitive frequency band is attenuated. This may include a plurality of analytical instruments integrated and/or stacked to provide the characterization of nanoparticles and macromolecules and may therefore include dynamic light scattering and electrophoretic mobility detection measurement instruments or the like. Although vibration isolation mounts have been used for many years, a vibration isolation mount must also serve a secondary purpose. Dynamic light scattering and electrophoretic mobility detection measurement instruments are often constructed as multiple devices including ultraviolet (UV) detectors, differential refractometer or refractive index (dRI) detectors, and multi-angle and dynamic light scattering (MALS/DLS) instruments, and the like stacked on top of and integrated with an FFF instrument 11 comprising mass flow controllers, for example, shown in the instrument tower 10 in FIG. 1. A first arrangement includes the placement of the FFF instrument 11 on a benchtop or other surface so that it floats on its vibration isolation mount and put a shelf over it that holds the analysis instruments. A second arrangement is to simply stack the analysis instruments directly on top of the FFF instrument 11. In this case the resulting instrument tower 10 is also floated on the vibration isolation feet. If several instruments 12-15 are stacked on the FFF instrument 11, the resulting tower 10 can become unstable, and potentially unsafe. Therefore, as a secondary goal addressed by embodiments of the present inventive concept, an isolation system includes a weight-based stop so that the tower 10 ceases to float and becomes rigid. Accordingly, these embodiments meet the competing goals of vibration isolation and having a weight-based hard stop.

A spring foot assembly in accordance with embodiments herein can reject the 80 Hz vibration frequency and its harmonic frequencies associated with typical mass flow controller systems and can reduce the vibration pickup by more than four times (4×). A spring foot assembly in accordance with embodiments herein can also isolate vibration frequency pickups when there is no instrument stacking, e.g., no apparatuses on top of the fraction collector in FIG. 1. Here, the spring foot assembly is constructed to provide a hard stop when there are MALS instruments or the like weighing 25 lbs. or more that are stacked on the fraction collector. Multiple foot assemblies may be used, for example, coupled to each corner of the bottom surface of the fraction collector, where each foot assembly may accommodate a different load.

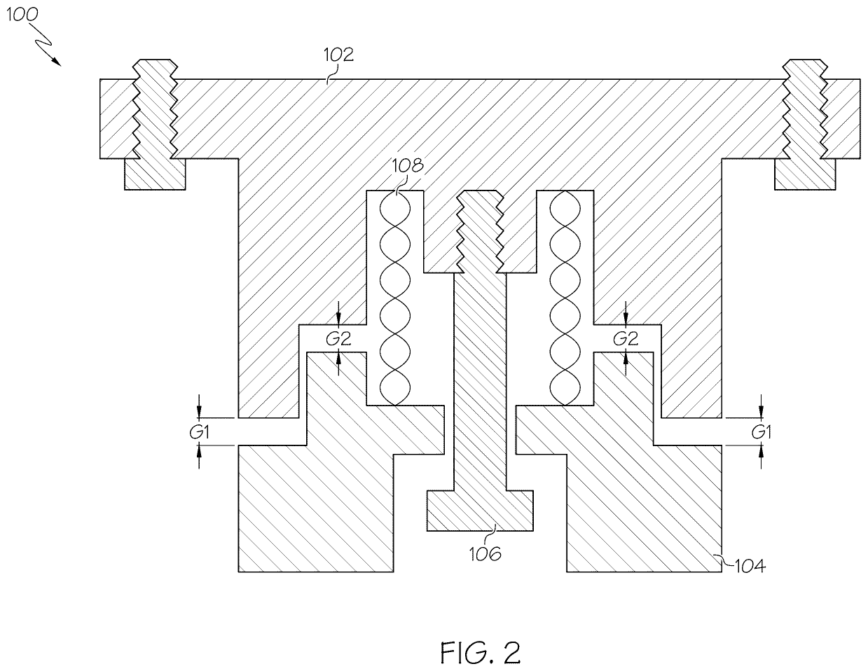

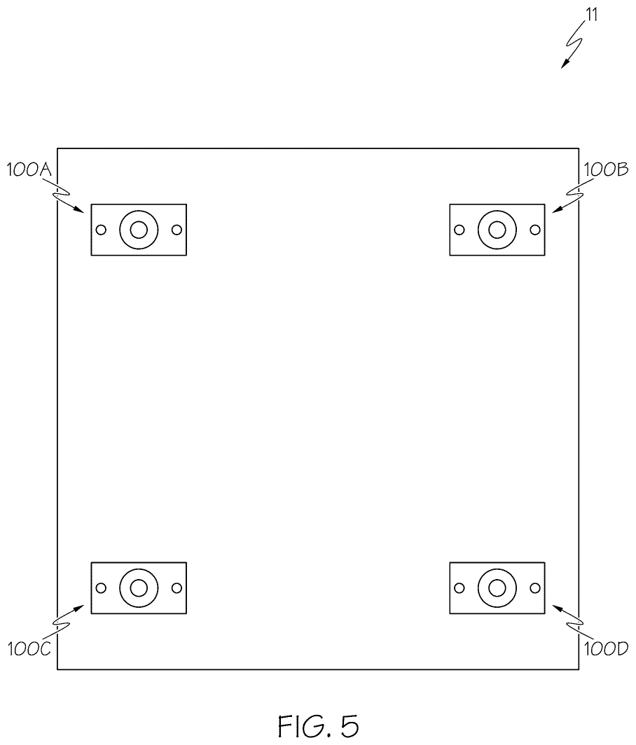

FIG. 2 is an illustrative view of a spring foot assembly 100 of a vibration isolation system, in accordance with an embodiment. Multiple spring foot assemblies 100 may be coupled to the bottom of an instrument, for example, positioned at each of four corners of the FFF instrument 11 shown in FIGS. 1 and 5 but not limited thereto, for example, a rear left 100A, rear right 100B, front left 100C, and front right 100D of the bottom surface of the instrument 11, for example, shown in FIG. 5. As explained herein, each assembly 100A-100D (generally, 100) may have a different configuration because the weight of the instrument may be non-uniform. For example, the instrument may have a heavy motor at the rear of the instrument resulting in a disproportionate weight distribution relative to the front of the instrument, therefore requiring foot assemblies 100 having different configurations at the front and rear of the instrument.

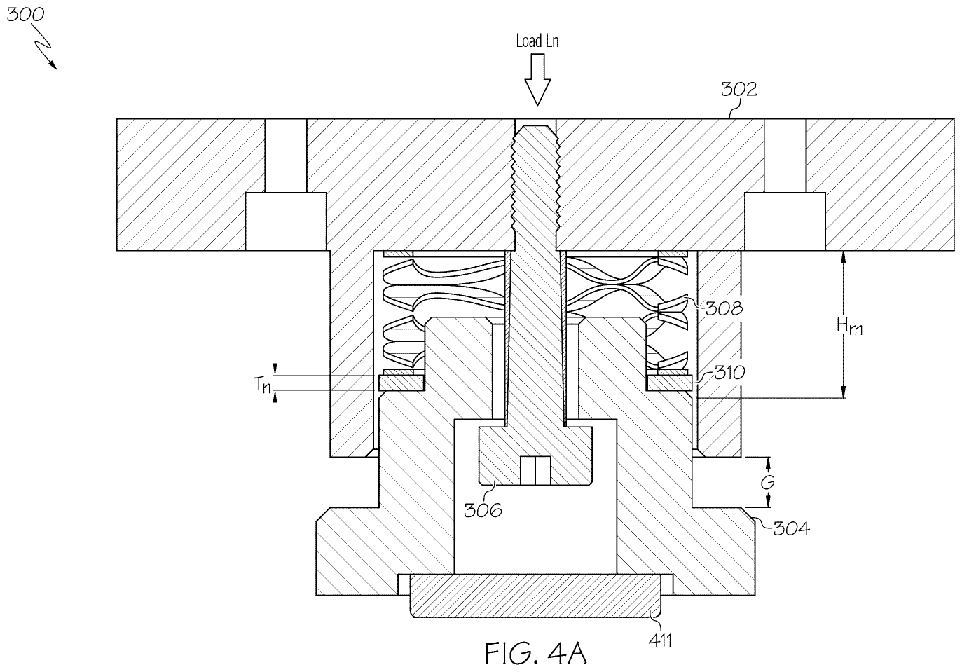

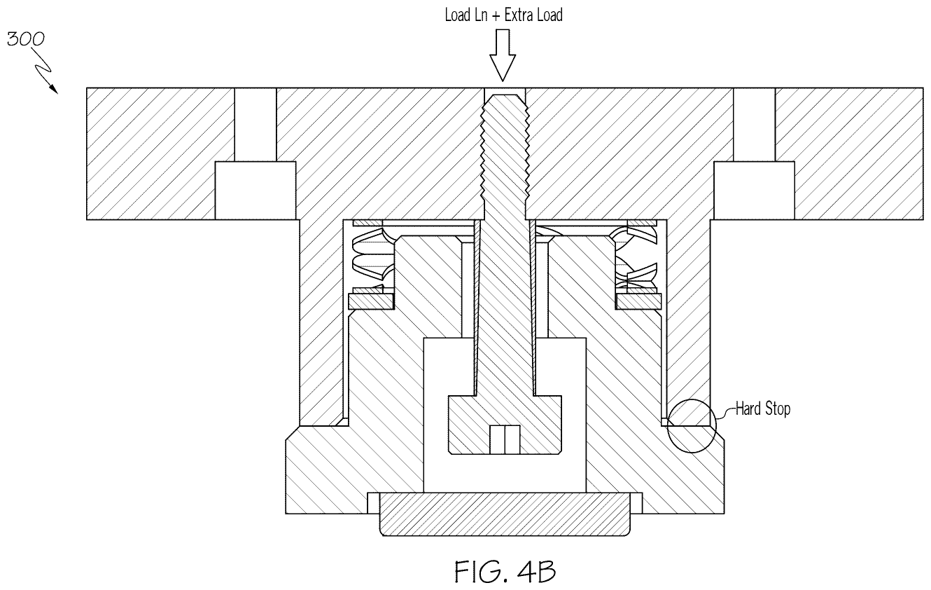

In some embodiments, a spring foot assembly 100 includes an upper housing 102, a lower housing 104, a shoulder bolt 106, and a spring 108. The upper housing 102 may be coupled to a bottommost instrument of a stack, or a surface of a standalone instrument. The lower housing 104 is constructed and arranged for positioning on a base, for example, a table, bench, or the like, or directly on a ground surface, such as a laboratory floor. The upper housing 102 and the lower housing 104 are constructed and arranged so that the spring 108 is sandwiched between them so that when a force is applied to the upper housing (see, for example, FIGS. 4A and 4B) by the weight of the instrument and optionally the additional weight of other instruments stacked on the instrument, e.g., shown in FIG. 1, to which the spring foot assemblies are coupled, the spring 108 provides a predetermined spring constant that determines the configuration of a given spring foot assembly 100, for example, the thickness of a washer shim 210 and/or the size of a gap, described in greater detail below. In some embodiments, the spring 108 is a wave spring, also referred to as a stack wave spring, which has a substantially flat top and bottom surface for abutting flat surfaces of the upper housing 102 and lower housing 104, respectively, for example, shown in the Appendices provided herewith. A stack wave spring 108 may have a predetermined spring constant, for example, 157 lb./in.

The shoulder bolt 106 is configured for insertion through a hole in the lower housing 104 and terminating in a threaded hole of the upper housing 102 for sandwiching the spring 108 in a cavity between the upper housing 102 and the lower housing 104. In doing so, the shoulder bolt 106 provides an initial fixed compression to the spring. The shoulder bolt 106 when threaded into the upper housing 102 can determine a distance between surfaces of the upper housing 102 and lower housing 104, for example, adjusting a gap G1, G2 between the housings 102, 104. As shown in FIG. 2, a first gap G1 is at an outermost region of the upper housing and the lower housing. The outermost region of the upper housing 102 has a length that is greater than an interior region adjacent the outermost region. Conversely the outermost region of the lower housing 104 has a length that is less than a length of an interior region adjacent the outermost region. The second gap G2 is between the interior region of the upper housing 102 and the lower housing 104. In some embodiments, the second gap G2 and interior regions of the upper and lower housing are proximal to the spring 108.

Also, the shoulder bolt 106 can set a compression in the spring 108 to provide consistent spacing. The shoulder bolt 106 is preferably along a center axis of the spring foot assembly. Accordingly, the shoulder bolt 106 and gaps G1, G2 between the upper and lower machined components 102, 104 ensures and enforces concentricity. A stop can be defined by either of the two gaps G1, G2, or one of the gaps G1, G2 could be eliminated by making the lower housing 104 narrower. It is important to make sure that the head of the shoulder bolt 106 is still recessed when the upper housing 102 and lower housing 104 hit the stops.

In order to change the spring preloading, one or more washers (not shown in FIG. 2 but shown in other figures herein) can be positioned under the spring 108, and they will be captured. In some embodiments, the upper housing 102 and lower housing 104 have cup-shaped configurations, and a stack wave spring, is captured between the two cups. In some embodiments, an adhesive non-skid rubber disk 411 (see FIGS. 4A and 4B) can be positioned over the shoulder bolt head.

The spring foot assembly 100 may support the following requirements, but not limited thereto. In some embodiments, the spring foot assembly 100 nominally provides a 2-4 mm compression. In some embodiments including multiple spring foot assembles, for example, shown in FIG. 5, there is no more than 5 mm between lightest and heaviest foot, e.g., 2 kg and 12 kg, respectively. In some embodiments, it is desirable to float an FFF instrument 11 having a weight of 55 lbs (25 kg) and at least 1 mm gap between the top housing 102 and the lower housing 104. Here, it is desirable to bottom out or stop due to the gaps with the addition of instruments weighing up to 135 lb (61 kg), or more. Preferably, the compression should not exceed 50% of the free height of the wave spring, or to not compress the spring 108 closer than 1 mm from its “solid length”. The free height refers to the height of the wave spring at no load. In other words, the spring 108 may act as a “solid” when it is compressed to a point where no further compression is possible. The ability to add different washer shims on different feet if required. The desire for the spring 108 to connect into the cup-shaped housings 102, 104 so that the foot assembly doesn't fall apart. Accessories such as wire, plastic clip, or a cotter/spring pin may be included in the cups to retain it. In some embodiments, a foot weighing 2 kg has only a 0.7 mm compression. In other embodiments, a 12 kg foot may have a 4.2 mm compression.

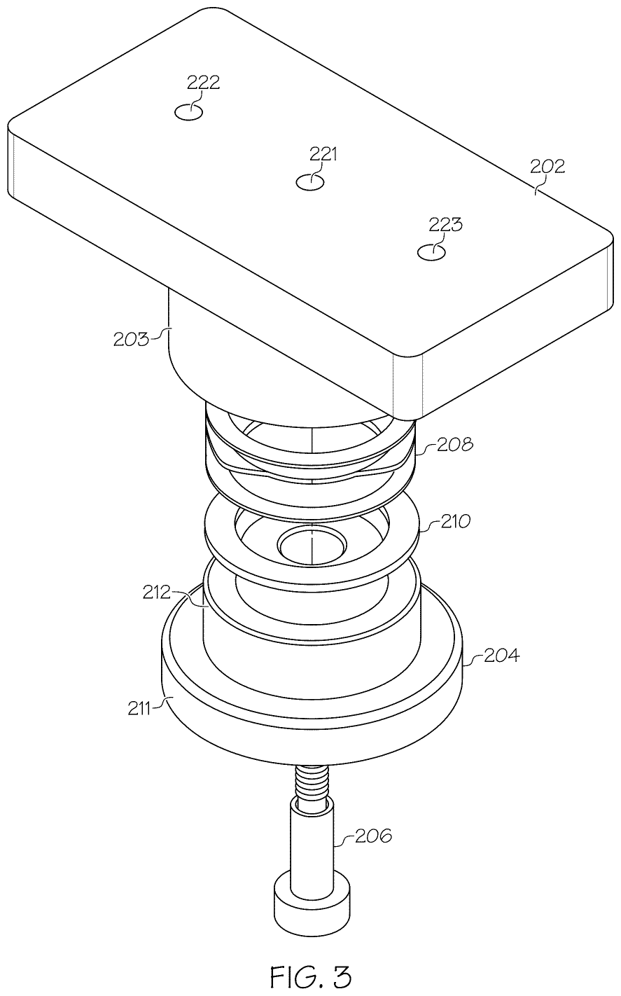

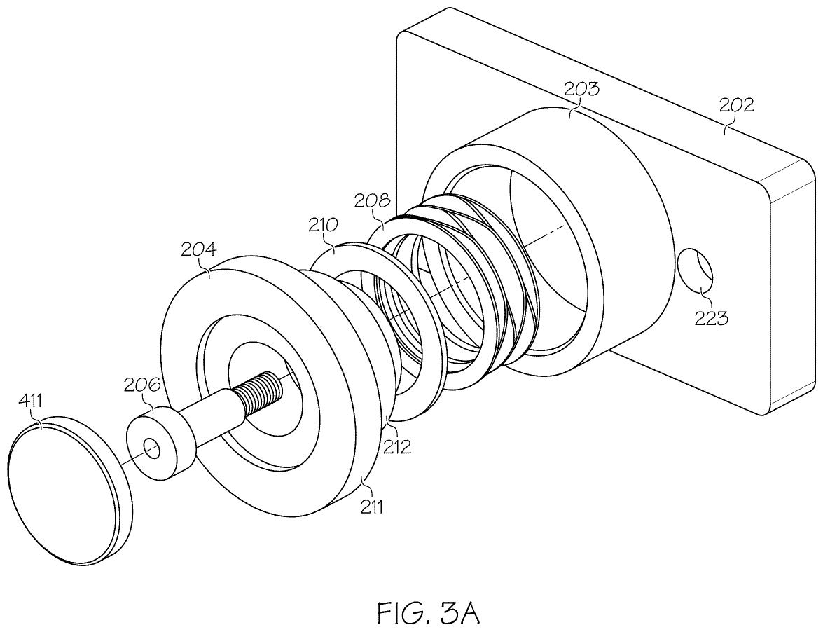

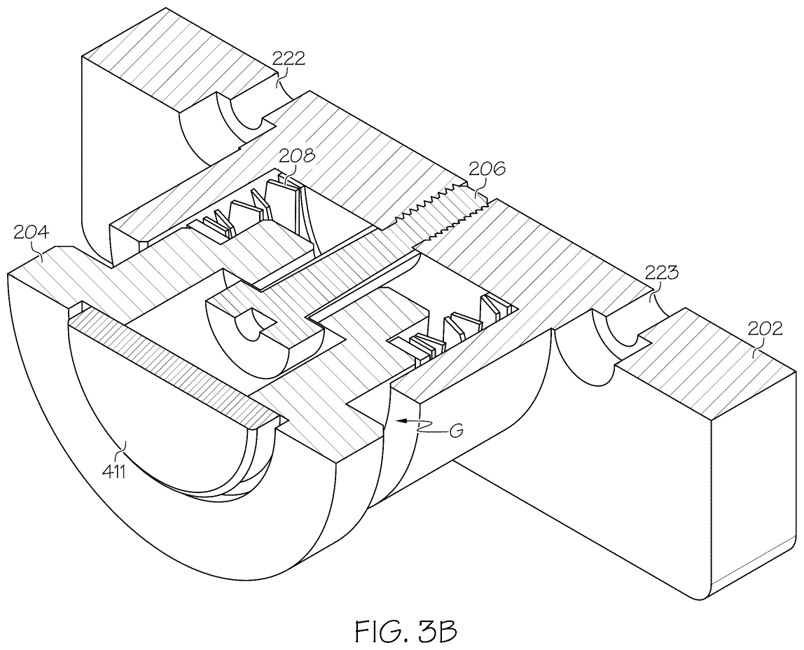

FIGS. 3, 3A, and 3B are perspective view of a spring foot assembly 200 of a vibration isolation system, in accordance with an embodiment. In some embodiments, the spring foot assembly 200 includes an upper housing 202, a lower housing 204, a shoulder bolt 206, and a spring 208. The shoulder bolt 206 and spring 208 may be similar to or the same as the shoulder bolt 106 and spring 108 of FIG. 2.

The upper housing 202 has a uniform width so that the shoulder bolt 206 and spring 208 are configured to directly contact a flat bottom surface. In contrast, the upper housing 102 in FIG. 1 has a protrusion from the bottom surface having a threaded opening for receiving the bolt 106 and about which at least a portion of the spring 208 is positioned. The upper housing 102 may have three holes along a length thereof. The center hole 221 extends along a center axis along which the bolt 206, lower housing 204, spring 208, and washer shim 210 also extend so that the bolt 206 can be threaded into the center hole 221. The two adjacent holes 222, 223 are arranged for receiving bolts for coupling the upper housing 202 to a bottom surface of an instrument, for example, the fraction collector shown in FIG. 1. In some embodiments, the upper housing 202 includes a cylindrical portion 203 that is positioned a stop-distance from a flange of the lower housing 204 in a spring-loaded configuration, resulting in a weight-based integrated stop.

The lower housing 204 has a first portion 211 of a first diameter and a second portion 212 of a second diameter less than the first diameter. A washer shim 210 can be positioned on the second portion 212. The spring 208 in turn is positioned about the second portion 210 to abut the washer shim 210. An anti-slip friction pad 411 can be positioned over an opening of the lower housing 204 into which the bolt 206 is inserted and positioned.

FIG. 4A depicts a spring foot assembly 300 in accordance with an embodiment receiving a first load. FIG. 4B depicts the spring foot assembly 300 of FIG. 4A receiving a second load. The spring foot assembly 300 includes an upper housing 302, a lower housing 304, a shoulder bolt 306 or screw or other attachment mechanism, a spring 308, and a washer shim 310 similar to those described in FIGS. 2-3B. Details thereof are not repeated for brevity. However, one difference over the spring foot assembly 100 in FIG. 2 is the presence of a single circumferential gap (G) instead of two gaps. As described herein, the gap (G) can be tuned between the upper and lower housings in view of the travel and load applied to the foot assembly. The adjustment washer 210 can change the pre-load on the wave washer 208 and thereby adjust the weight at which it hits the hard stop. In addition, the adjustment washer described herein can be used to compensate for the weight differences, or more specifically, so that different feet arranged about the instrument can accommodate different loads and address different vibrational requirements.

In FIGS. 4A and 4B, the thickness Tₙ of the washer shim 310 can be determined according to the following equation:

$${T}_{n} = {H}_{m} - ( F - \frac{{L}_{n}}{K} ) - G ,$$

where Tₙ is the thickness of the washer, subscript n represents the location of the foot since each foot might have different load Lₙ; Hₘ is the default height between the two mounting blocks, F is the free height of the spring, K is the rate constant of the spring, G is the default gap before hitting the hard stop without extra load on top of the instrument.

The default gap G depends on how much weight will be put on top of the instrument. In this example, the typical instrument may have a weight of ˜16.8 kg or more, which may result in a compression distance of ˜2.14 mm for the front left foot 300. Hence, the gap G is set to be 2.0 mm and the washer thickness Tₙ is set to 2.5 mm. The other feet 300, e.g., front right foot, etc. may have different washer thicknesses depending on the weight distribution, load requirements, and so on, for example, illustrated in the Appendices herewith. As shown in FIG. 4B, a hard stop between the upper and lower housings is formed, i.e., gap G=0, when a receiving the second load, referred to as an extra load.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. An apparatus comprising:
a spring foot, comprising:
an upper housing; and
a lower housing, comprising
an anti-slip friction pad;
a shoulder bolt to provide consistent spacing; and
an adjustment washer to adjust a weight-set point for switching between a spring-loaded configuration and a solid-loaded configuration;
wherein the upper housing cylinder is positioned a stop-distance from a flange of the lower housing in a spring-loaded configuration, resulting in a weight-based stop; and
wherein the adjustment washer is adjustable between a spring-loaded configuration to a solid-loaded configuration, based on a predetermined spring constant.

2. The apparatus of claim 1, wherein the anti-slip friction pad is positioned over an opening of the lower housing into which the shoulder bolt is inserted and positioned.

3. The apparatus of claim 1, further comprising a spring providing the spring constant positioned above the adjustment washer.

4. The apparatus of claim 3, wherein the spring includes a wave spring.

5. The apparatus of claim 1, wherein the adjustment washer has a thickness that changes a gap between the upper housing and the lower housing to provide the weight-based stop.

6. The apparatus of claim 5, wherein the gap includes a first gap between an outer region of the upper housing and the lower housing and a second gap between an interior region of the upper housing and the lower housing.

7. The apparatus of claim 1, wherein the upper housing includes a cylindrical portion that is positioned the stop-distance from the flange of the lower housing in the spring-loaded configuration.

8. A foot assembly for at least one vibration-sensitive analytical instrument, comprising:
an upper housing coupled to an instrument of at least one vibration-sensitive analytical instrument;
a lower housing constructed and arranged for positioning on a surface;
a default gap between the upper housing and the lower housing;
a coupling device extending through a center of the lower housing and coupling to the upper housing so that the upper housing can move vertically relative to the lower housing and adjust the gap according to a force applied the upper housing; and
a spring having a predetermined spring constant between the upper housing and the lower housing, the spring compressing when the force is applied to the upper housing so that the upper housing moves vertically relative to the lower housing until the default gap between the upper housing and the lower housing is reduced until the upper housing directly abuts the lower housing.

9. The foot assembly of claim 8, wherein the coupling device includes a shoulder bolt.

10. The foot assembly of claim 8, wherein the spring includes a wave spring.

11. The foot assembly of claim 8, further comprising at least one washer shim between the spring and the lower housing, the at least one washer shim having a thickness that changes the gap to provide a desired hard stop against the force applied to the upper housing.

12. The foot assembly of claim 8, wherein the gap includes a first gap between an outer region of the upper housing and the lower housing and a second gap between an interior region of the upper housing and the lower housing.

13. The foot assembly of claim 8, wherein the upper housing includes a cylindrical portion that is positioned the stop-distance from the flange of the lower housing in the spring-loaded configuration.

14. The foot assembly of claim 8, further comprising an anti-slip friction pad positioned over an opening of the lower housing into which the shoulder bolt is inserted and positioned.

15. A vibration isolation system, including:
first through fourth foot assemblies, each coupled to a corner of a bottom surface of a vibration-sensitive analytical instrument, each foot assembly comprising:
an upper housing coupled to an instrument of at least one vibration-sensitive analytical instrument;
a lower housing constructed and arranged for positioning on a surface;
a default gap between the upper housing and the lower housing;
a coupling device extending through a center of the lower housing and coupling to the upper housing so that the upper housing can move vertically relative to the lower housing and adjust the gap according to a force applied to the upper housing; and
a spring having a predetermined spring constant between the upper housing and the lower housing, the spring compressing when the force is applied to the upper housing so that the upper housing moves vertically relative to the lower housing until the default gap between the upper housing and the lower housing is reduced until the upper housing directly abuts the lower housing, wherein:
each of the first through fourth foot assemblies has a different gap thickness to accommodate a different force.

16. The vibration isolation system of claim 15, wherein each foot assembly further comprises an anti-slip friction pad positioned over an opening of the lower housing into which the shoulder bolt is inserted and positioned.

17. The vibration isolation system of claim 15, wherein the spring includes a wave spring.

18. The vibration isolation system of claim 15, wherein each foot assembly further comprises an adjustment washer having a thickness that changes the default gap to provide a weight-based stop.

19. The vibration isolation system of claim 15, wherein the gap includes a first gap between an outer region of the upper housing and the lower housing and a second gap between an interior region of the upper housing and the lower housing.

20. The vibration isolation system of claim 15, wherein the upper housing includes a cylindrical portion that is positioned the stop-distance from the flange of the lower housing.
